(19) United States
(12) Patent Application Publication
(10) Pub. No.: US 2008/0192456 A1
(43) Pub. Date: Aug. 14, 2008

(54) Artificial Window

(75) Inventors: Onno Van Tertholen, Eindhoven (NL); Cornelia Titia Staats, Eindhoven (NL); Joseph Franciscus Raymond Eijsermans, Eindhoven (NL); Piet Antonis, Eindhoven (NL); Lars Rene Christian Waumans, Eindhoven (NL); Gerritt Jan Teije Huijgen, Eindhoven (NL); Adrianus Sempel, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/915,741

(22) PCT Filed: May 23, 2006
(86) PCT No.: PCT/IB2006/051643

§ 371 Date: Nov. 28, 2007

(30) Foreign Application Priority Data
Jun. 1, 2005 (EP) 05104714.0

(51) Int. Cl. F21V 5/00

(52) U.S. Cl. 362/1

(57) ABSTRACT

The artificial window (1) for use in apartments which lack a window through which day light may enter, has a light box (10) in which three sets of color lamps as light sources (13R,13G,13B) are mounted behind a diffuser (14). A window frame (20) is present in front of the diffuser (14) and a transparent plate (21) in the window frame (20), remote from the diffuser (14). Drivers (15) are present to start, to operate and to dim the light sources (13) thereby allowing to imitate natural light at different seasonal and time conditions. A number of features are described that further enhance the appearance of a real window.

The invention relates to an artificial window comprising:

a light box having a rear wall and a light exit window opposite the rear wall, and containing a plurality of electric light sources mounted adjacent the rear wall;

a diffuser adjacent the light exit window;

a window frame in front of the diffuser;

drivers for starting and operating the light sources, electrically connected to the light sources; and

a user interface for receiving command signals.

An embodiment of such an artificial window is known from GB-A-2 223 565.

There are numerous public or office buildings having spaces which lack windows through which daylight can enter, e.g. control rooms, conference rooms, waiting rooms in hospitals, shops, archives, libraries. When people are present in such rooms, the absence of windows affects their efficiency. Moreover, regulations in many countries forbid presence in such rooms for long periods. It is therefore important to have the disposal of a luminaire which imitates a window through which daylight enters.

When mounted on a wall, the known artificial window has a number of vertically arranged elongate fluorescent lamps. The lamps emit white light at a color temperature of 3000K. The diffuser is enclosed by the light box and the window frame. When the lamps are lit, a bright white screen surrounded by the window frame is obtained, which is recommended for treatment of patients suffering from depressions.

In this respect, the known artificial window provides little more than opal screens having similar lamps at the rear, which are to be placed on a table or a desk to take a light shower. It simulates a blank screen lit by the sun, e.g. at noon.

It is a disadvantage of the known artificial window that it provides just a poor imitation of a real window.

It is an object of the invention to provide an artificial window of the type described in the opening paragraph, which is able to give a more realistic impression of a window through which light enters at daytime.

This object is achieved in that the light sources comprise a first set of light sources emitting red light during operation, a second set of light sources emitting green light during operation and a third set of light sources emitting blue light during operation, the light sources of the first, second and third set being mounted in a mixed arrangement,

the drivers are also able to dim the light sources, and are each connected to at most a respective portion of the number of light sources of a set, while they are individually controllable, and

a transparent plate is present in the window frame, remote from the diffuser.

During operation, this combination of features gives the artificial window of the invention a more realistic appearance of a daylight window. The light sources of different colors and the possibility of operating them also in a dimmed manner allow creation of a window of several color temperatures, corresponding to the time of day and year. At sunset, the window can emit light of a different color temperature than at noon. The actual light generated by the window can be chosen by the user. Moreover, the window provides the possibility of producing color patterns, which are not to be interpreted as pictures. A lower portion of the window, mounted on a wall, may e.g. be green, while a higher portion may be blue or purple. The impression of a horizon can be created in this manner.

A window has a pane through which light enters and which can be looked through. The transparent plate, which may be of glass or of an artificial resin, such as polymethylmethacrylate, or acrylic glass, behind which the diffuser is present at some distance and through which a rear portion of the window frame is observable, creates depth, i.e. the third dimension, which contributes to the impression of a real window. Additionally, it gives the reflections which are normal in window panes.

The artificial window of the invention may be mounted on e.g. a vertical wall or on a beveled wall portion which is the bottom side of a roof.

In an embodiment, the window frame has a first frame portion and a second, opposite frame portion at a mutual distance d and a respective panel extending therefrom towards the diffuser. The panels are illuminated when the window is operated. They contribute to giving a three-dimensional impression which adds to the “reality” of the window. The panels may have a finish and a pattern of bricks to imitate a reveal, or the boundary of a recess in a facade in which a window is mounted. The panels may alternatively have a finish of concrete, planks, metal or other materials of which the facade is made. The panels may alternatively have the finish of board or plywood, e.g. when the window is to be mounted on a beveled wall so as to imitate a roof window.

It is an advantage to have the panels extend towards, rather than up to the diffuser, although it is possible in the artificial window of the invention that panels extend up to the diffuser. It gives a greater impression of space, or of three dimensions, when the panels do not touch the diffuser. It is suggested that it should be possible to look beyond the panels to the right or the left if the transparent plane were not in position and one could lean out of the window.

It is favorable to further improve the three-dimensional effect and thereby the realistic effect of the window if the panels have a mutual distance D which is larger than d. They are then not directly beside and behind the window pane, but displaced laterally, e.g. to join the outside extremity of the frame portion.

The building in which the artificial window is or will be used may require the first and the second frame portion to be curved along at least a part of their length, e.g. so as to meet each other in the middle.

In an embodiment, a processor is coupled to the drivers of the light sources so as to control the drivers in response to a signal received by the user interface. A few basic data, such as the time of day, brightness and pattern can than be entered so as to obtain the desired appearance of the window. The data entry into the user interface of the window can be given manually via a remote control or via signals from an outside sensor.

In a modification of this embodiment, a memory is coupled to the processor and comprises programs for execution by the processor in response to a signal received by the user interface. This facilitates the use of the window, because a program can now be chosen that meets the user's wishes. For instance, a program may cause the window to display an imitation of the light changing in brightness and color from sunrise to noon to sunset, or a portion thereof, e.g. real time. The memory may be integral with the processor.

The light sources may be, for instance, light-emitting diodes (LEDs) or particularly fluorescent lamps. These lamps have a high yield and are easily available. T5 fluorescent lamps, lamps having a diameter of about 15 mm, are particularly suitable, also because of their relatively low volume. When fluorescent lamps are used, each lamp generally has its own driver, or two adjacent lamps share a driver. When LEDs are used, a few neighboring LEDs of the same color may share a driver.

In an embodiment, the light box contains elongate fluorescent lamps as light sources, which lamps extend transversely to the first and the second frame portion. In this embodiment, a light pattern as described hereinbefore, in which the horizon is imitated can easily be obtained, even with lamps which are about as long as the width of the window. When shorter lamps are used, e.g. lamps of a lower power consumption, or lamps comprising two parallel tubular portions, as is the case in PL lamps, the light pattern of the window can also be segmented in the longitudinal direction of the lamps, which will generally be the horizontal direction. This is important for simulating the position of the sun. It is favorable if the lamps are able to consume a power of about 400 W to about 650 W per square meter of rear wall surface.

In a favorable embodiment of the window of the invention, at least one lamp provided with a reflector is present between the diffuser and the window frame, adjacent a third frame portion which bridges the first and the second portion, concealed by the frame and coupled to an own driver for starting, operating and dimming, and directed to radiate light through the transparent plate during operation. In this embodiment, the window is destined to be mounted with the third frame portion at the top. It is favorable if a high-pressure discharge lamp, such as a metal halide discharge lamp in a ceramic discharge vessel, of e.g. 70 W and having a color temperature of 3000K or 4000K or a high-pressure sodium lamp of e.g. 100 W, emitting white light, or alternatively a halogen incandescent lamp of e.g. 150 W is present. These lamps are available in a compact size and their light source is compact, so as to allow the associated reflector, which may be integral or assembled with the lamp, to shape the light generated by the lamp into a beam, which may be narrow and well limited. Depending on the direction of the lamp and the reflector, the beam enters the apartment in which the window is mounted only, or also hits and illuminates a portion of the window frame. Inside the apartment, the beam may create shadows of bodies present adjacent the window, thereby further enhancing the impression of a real daylight window. The use of a halogen incandescent lamp has the advantage that its color temperature lowers upon dimming.

A high-pressure metal halide discharge lamp having a ceramic discharge tube and a filling comprising, inter alia, sodium iodide and cesium iodide may be used as said lamp, together with a driver which is able to cause an AC current having a variable DC component to flow through the lamp. Such lamps and drivers are known from WO 03/098.659. By varying the DC component of the current, the driver causes the lamp to vary the color of the light generated. The color changes are based on demixing the filling of the lamp.

In a modification of this embodiment, the at least one lamp is movable along a rail which extends between the first and the second frame portion. The lamp may be caused to change its angle to these frame portions, while moving along the rail. In this modification, the relative movement of the sun is strongly accentuated. For instance, the lamp may simulate first a period early in the morning in which the sun has a low position with respect to the earth, and hardly enters the apartment, but illuminates the right standing portion of the window rather high, when the lamp is positioned near the upper left corner of the window. Later in the day, the lamp may be directed to have the beam illuminate the standing window frame portion lower and to enter the apartment, and still later, it may be directed to throw the beam from a position in the middle of the window less far into the apartment. This feature enhances the realistic, dynamic character which the window already has because of its property to create dynamic, changing, patterns on the diffuser.

In a modification of this embodiment, several lamps provided with a reflector are present, each lamp having its own angle to the first and the second frame portion. These lamps may be switched so that they operate alternatingly.

In a further embodiment, a fourth frame portion is present opposite the third frame portion, while a shelf is present adjacent the fourth frame portion. This shelf represents a window sill. When objects are placed thereon, a shadow is created which enhances the appearance of the artificial window as a real window. If desired, curtains and or a lamellae screen may be added when the artificial window is installed.

The artificial window may not only be applied on a beveled wall, but also in a corner of two walls or in the corner of a wall and a ceiling. To this end, it is important if the artificial window is shaped to fit in a corner between two constructional planes which are at right angles to each other.

Embodiments of the artificial window of the invention will now be described and further elucidated with reference to the drawings, in which:

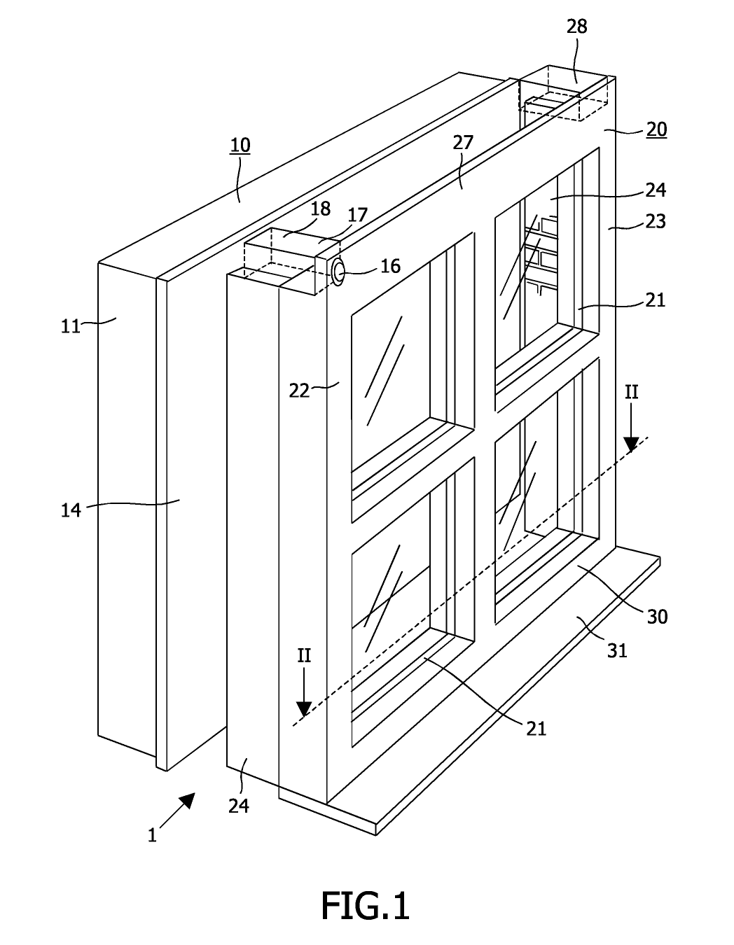

FIG. 1 is a schematic perspective view of a first embodiment;

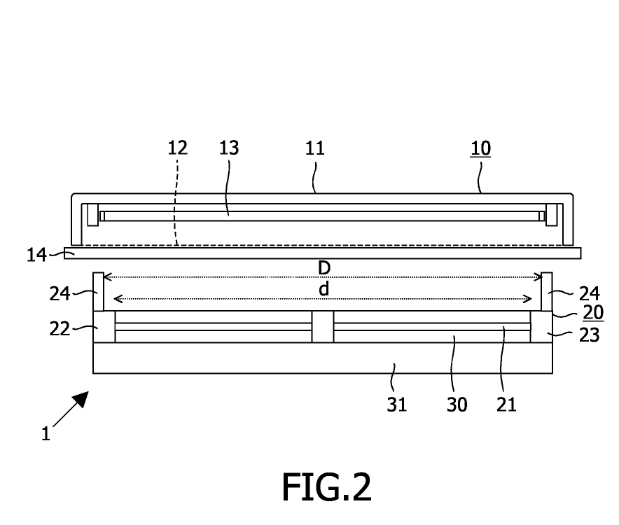

FIG. 2 is a cross-section taken on the line II-II in FIG. 1;

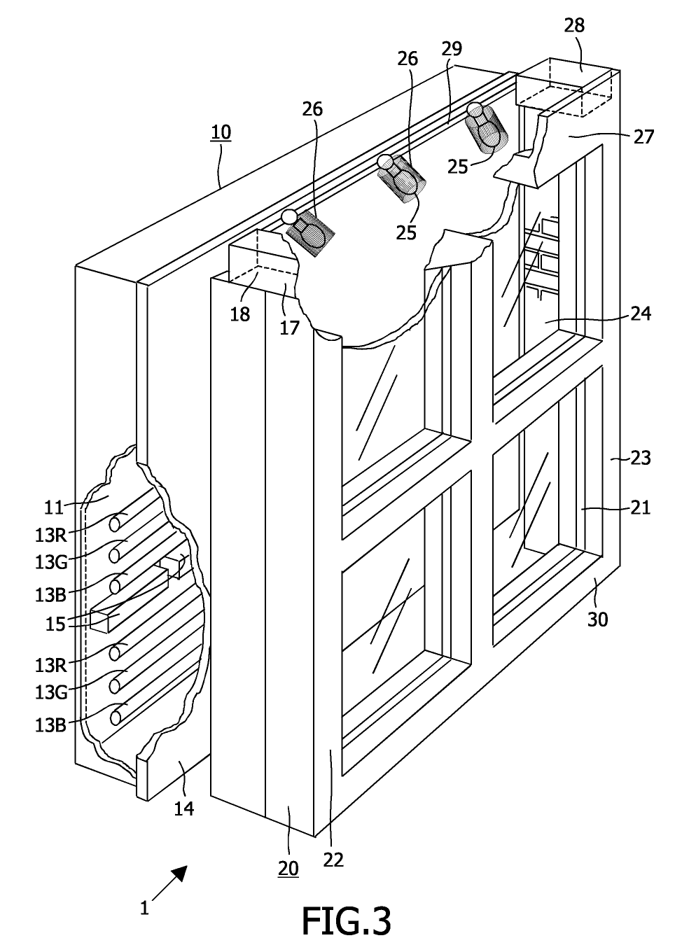

FIG. 3 shows the embodiment of FIG. 1, partly broken away;

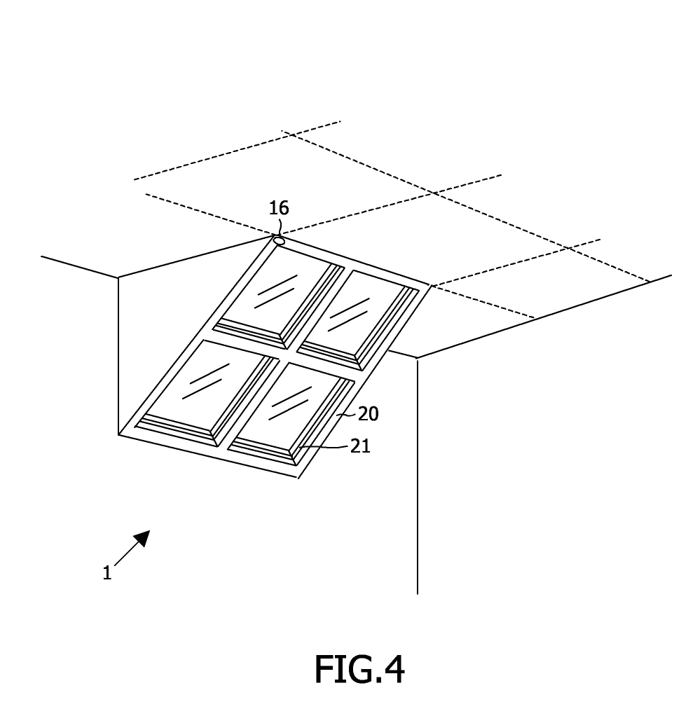

FIG. 4 is a perspective view of a second embodiment.

In the embodiment of FIGS. 1, 2 and 3, the artificial window 1 has a light box 10, see FIGS. 2 and 3, with a rear wall 11 and a light exit window 12 opposite the rear wall 11. The light box is made of a reflective material, in the Figures of metal sheet having a white highly reflective coating which has a diffusing reflection component, e.g. of the type normally applied in luminaires. A plurality of electric light sources 13 are mounted in the light box 10 adjacent the rear wall 11. In the Figures, the light sources 13 are tubular fluorescent lamps of 15 mm diameter. A diffuser 14 of opal polyacrylate is present adjacent the light exit window. A window frame 20 is mounted in front of the diffuser 14. The window frame 20 may consist of, for instance, wood, artificial resin or aluminum, but at least a wooden appearance is preferred. Drivers 15 for starting and operating the light sources are electrically connected to the light sources 13. The artificial window 1 has a user interface 16 for receiving command signals.

The light sources 13, see FIG. 3, comprise a first set of light sources 13 emitting red light 13R during operation, a second set of light sources emitting green light 13G during operation and a third set of light sources emitting blue light 13B during operation. The light sources 13R of the first set, 13G of the second set and 13B of the third set are mounted in a mixed arrangement. The drivers 15 are also able to dim the light sources 13, and they are each connected to at most a respective portion of the number of light sources 13R, 13G, 13B of a set. In the embodiment shown, each light source 13 has its own driver 15. The drivers 15 are individually controllable. A transparent plate 21 is present in the window frame 20, remote from the diffuser 14.

In the Figures, a crossbar is present in the window frame 20, but this is not essential. The crossbar virtually or actually divides the transparent plate 21, in the Figures a glass pane, into four portions.

The window frame 20 has a first frame portion 22 and a second, opposite frame portion 23 at a mutual distance d, and a respective panel 24, see FIG. 2, extending therefrom towards the diffuser 14. The panels 24 have a pattern and a finish of bricks.

In the embodiment shown, the panels 24 have a mutual distance D which is larger than d.

A processor 17 is e.g. electrically coupled to the drivers 15 of the light sources to control the drivers in response to a signal received by the user interface 16. Cabling is left out in the Figures for clarity.

A memory 18 is coupled to the processor 17. The memory 18 comprises programs for execution by the processor 17 in response to a signal received by the user interface 16. The processor 17 and the memory 18 are integrated.

The elongate fluorescent lamps used as light sources 13 extend transversely to the first and the second frame portion 22,23.

At least one lamp 25, see FIG. 3, provided with a reflector 26 is present between the diffuser 14 and the window frame 20, adjacent a third frame portion 27 which bridges the first and the second portion 22,23, concealed by the frame 20 and coupled to an own driver 28, and directed to radiate light through the transparent plate 21 during operation.

The at least one lamp 25 is movable along a rail 29 which extends between the first and the second frame portion 22,23, while changing an angle to these frame portions 22,23. In the Figure, three such lamps 25 and reflectors 26 are depicted to show some of the positions which said at least one lamp 25 may occupy, but also to illustrate an embodiment in which several lamps 25 are present. In the latter case, mounting to a rail is not necessary if it is not required to move the lamps.

In FIG. 1, the window frame 20 has a fourth frame portion 30 opposite the third frame portion 27 and a shelf 31 functioning as a window sill is present adjacent the fourth frame portion 30.

The embodiment of the artificial window 1 of the invention shown in FIG. 4 has a set of tubular fluorescent lamps which, during operation, emit red, green and blue light, respectively, as light sources 13 in its light box 10, behind a diffuser 14 with a spaced transparent plate 21 in front of the diffuser 14, as is the case in the embodiment of FIGS. 1, 2 and 3. It can be operated as the embodiment of FIGS. 1, 2 and 3, but is shaped to fit in a corner between two constructional planes which are at right angles to each other, i.e. in a corner between a ceiling and a vertical wall. Because of its destination, it is important that input can be given to the user interface 16 via a remote control device.

1. An artificial window (1) comprising:
a light box (10) having a rear wall (11) and a light exit window (12) opposite the rear wall (11), and containing a plurality of electric light sources (13) mounted adjacent the rear wall (11);
a diffuser (14) adjacent the light exit window (12);
a window frame (20) in front of the diffuser (14);
drivers (15) for starting and operating the light sources, electrically connected to the light sources (13); and
a user interface (16) for receiving command signals,
characterized in that
the light sources (13) comprise a first set of light sources emitting red light (13R) during operation, a second set of light sources emitting green light (13G) during operation and a third set of light sources emitting blue light (13B) during operation, the light sources (13) of the first (13R), second (13G) and third set (13B) being mounted in a mixed arrangement,
the drivers (15) are also able to dim the light sources (13) and are each connected to at most a respective portion of the number of light sources (13R,13G,13B) of a set, while they are individually controllable, and
a transparent plate (21) is present in the window frame (20), remote from the diffuser (14).

2. An artificial window as claimed in claim 1, characterized in that the window frame (20) has a first frame portion (22) and a second, opposite frame portion (23) at a mutual distance d, and a respective panel (24) extending therefrom towards the diffuser (14).

3. An artificial window as claimed in claim 2, characterized in that the panels (24) have a mutual distance D which is larger than d.

4. An artificial window as claimed in claim 1, characterized in that a processor (17) is coupled to the drivers (15) of the light sources to control the drivers in response to a signal received by the user interface (16).

5. An artificial window as claimed in claim 4, characterized in that a memory (18) is coupled to the processor (17), comprising programs for execution by the processor (17) in response to a signal received by the user interface (16).

6. An artificial window as claimed in claim 2, characterized in that the light box (10) contains elongate fluorescent lamps as light sources (13), which lamps extend transversely to the first and the second frame portion (22,23).

7. An artificial window as claimed in claim 2, characterized in that at least one lamp (25) provided with a reflector (26) is present between the diffuser (14) and the window frame (20), adjacent a third frame portion (27) which bridges the first and the second portion (22,23), concealed by the frame (20) and coupled to an own driver (28), and directed to radiate light through the transparent plate (21) during operation.

8. An artificial window as claimed in claim 7, characterized in that the at least one lamp (25) is movable along a rail (29) which extends between the first and the second frame portion (22,23).

9. An artificial window as claimed in claim 7, characterized in that several lamps (25) provided with a reflector (26) are present, each having its own angle to the first and the second frame portion (22,23).

10. An artificial window as claimed in claim 7, characterized in that a fourth frame portion (30) is present opposite the third frame portion (27), while a shelf (31) is present adjacent the fourth frame portion (30).

11. An artificial window as claimed in claim 1, characterized in that it is shaped to fit in a corner between two constructional planes which are at right angles to each other.
